(19) United States
(12) Patent Application Publication
(10) Pub. No.: US 2009/0118145 A1
(43) Pub. Date: May 7, 2009

(54) METHOD FOR PRODUCING PROPPANT USING A DOPANT

(75) Inventors: Brett Allen Wilson, Lafayette, LA (US); Rudolph A. Olson, III, Hendersonville, NC (US); Walter G. Luscher, Kennewick, WA (US); John R. Hellmann, State College, PA (US); Barry E. Scheetz, Lemont, PA (US)

Correspondence Address: HAYNES AND BOONE, LLP;IP Section, 2323 Victory Avenue, Suite 700, Dallas, TX, 75219, US

(73) Assignees: CARBO CERAMICS INC., Irving, TX (US); The Penn State Research Foundation, University Park, PA (US)

(21) Appl. No.: 12/253,681

(22) Filed: Oct. 17, 2008

Related U.S. Application Data
(60) Provisional application No. 60/981,296, filed on Oct. 19, 2007.

(51) Int. Cl. C09K 8/80

(52) U.S. Cl. 507/276

(57) ABSTRACT

A method for producing sintered pellets and sintered pellets produced therefrom including mixing a dopant with water and kaolin clay to form substantially round and spherical green pellets and sintering the pellets to form a proppant. The dopant is selected from the group consisting of potassium carbonate, potassium sulfate, potassium chloride, mica, kalsilite, and combinations thereof.

### CROSS-REFERENCE TO RELATED APPLICATION

This patent application is a non-provisional of U.S. Patent Application No. 60/981,296, filed on Oct. 19, 2007, which is incorporated by reference herein in its entirety.

### FIELD OF THE INVENTION

Embodiments of the present invention relate generally to a method for producing propping agents (proppants), which are used to prevent induced fractures in subterranean formations in oil, gas and geothermal wells from closing.

### BACKGROUND ART

Embodiments of the present invention relate to oil and gas well proppants and, more particularly, to sintered proppants in a broad range of applications.

Oil and natural gas are produced from wells having porous and permeable subterranean formations. The porosity of the formation permits the formation to store oil and gas, and the permeability of the formation permits the oil or gas fluid to move through the formation. Permeability of the formation is essential to permit oil and gas to flow for production of the well. Sometimes the permeability of the formation holding the gas or oil is insufficient for economic recovery of oil and gas. In other cases, during operation of the well, the permeability of the formation drops to the extent that further recovery becomes uneconomical. In such cases, it is necessary to fracture the formation and prop the fracture in an open condition by means of a proppant material or propping agent. Such fracturing is usually accomplished by hydraulic pressure, and the proppant material or propping agent is a particulate material, which is carried into the fracture in a slurry of fluid and propping agent. This propping agent must have sufficient strength to resist crushing by the closure stresses of the formation. The deeper the well, generally the stronger the proppant needs to be to resist crushing.

Manufactured proppants mainly contain alumina (aluminum oxide) and silica (silicon oxide) in various proportions. It is assumed that the content of these oxides in the pellets principally defines proppant performance. Kaolins (kaolin clays) are extensively used as alumina-silica raw stock for proppant manufacturing. Other oxides such as iron, titanium, and alkali elements (Na, K, Ca, and Mg) are found in kaolin and can impact the strength of the proppant.

Eurasian Patent No. 007864 discloses that potassium oxide (K₂O) is considered an impurity found in kaolin that is typically associated with strength degradation when concentrations of potassium oxide exceed 0.20 percent by weight. FIG. 7 of Eurasian Patent No. 007864 illustrates that the higher the content of potassium oxide in kaolin, the higher the crushability of the pellets, i.e. strength of the pellets decreases.

### BRIEF SUMMARY OF THE INVENTION

The embodiments described herein provide a method of manufacturing proppants using a dopant. The dopant is added in an amount to achieve sintered pellets having a potassium oxide content more than about 0.21 to about 3.0 percent by weight. Sintered pellets doped to achieve a potassium oxide content of more than about 0.21 to about 3.0 percent by weight exhibit unexpectedly improved strengths. Surprisingly, the doped sintered pellets show enhanced mullite and glass formation at lower sintering temperatures.

An embodiment of the present invention relates to a method for producing sintered pellets including mixing a dopant with water and kaolin clay having more than 44 percent by weight aluminum oxide to form substantially round and spherical green pellets and sintering the pellets. The dopant is selected from the group consisting of potassium carbonate, potassium sulfate, potassium chloride, mica, kalsilite, and combinations thereof. The dopant is added to the water and kaolin clay mixture in an amount effective to achieve sintered pellets having more than about 0.21 to about 3.0 percent by weight potassium oxide.

Another embodiment provides a method for producing sintered pellets including mixing an effective amount of dopant selected from the group consisting of potassium carbonate, potassium sulfate, potassium chloride, mica, kalsilite, and combinations thereof with water and kaolin clay having more than 44 percent by weight aluminum oxide to form substantially round and spherical green pellets and sintering the pellets; wherein the sintered pellets exhibit specific strengths exceeding 88 MPa-cc/g.

A method for producing sintered pellets having improved quantities of mullite and glass including mixing potassium carbonate with water and kaolin clay to form substantially round and spherical green pellets and sintering the pellets at temperatures between about 1400° C. to about 1450° C., and, preferably at about 1450° C.

### BRIEF DESCRIPTION OF THE DRAWINGS

FIG. 1 illustrates varying amounts of potassium oxide blends and sintering temperatures.

FIG. 2 is a graph showing the strength responses of kaolinite blend doped to varying concentrations of K₂O including undoped, 0.25% by weight K₂O, 0.5% by weight K₂O, and 1.0% by weight K₂O.

FIGS. 3A and 3B are optical micrographs of a cross section of an undoped pellet sintered at 1450° C. taken at magnifications of 1000× and 5000×, respectively.

FIGS. 3C and 3D are optical micrographs of a cross section of an undoped pellet sintered at 1500° C. taken at magnifications of 1000× and 5000×, respectively.

FIGS. 3E and 3F are optical micrographs of a cross section of an undoped pellet sintered at 1550° C. taken at magnifications of 1000× and 5000×, respectively.

FIGS. 4A and 4B are optical micrographs of a cross section of a pellet doped with 0.25% by weight K₂O sintered at 1450° C. taken at magnifications of 1000× and 5000×, respectively.

FIGS. 4C and 4D are optical micrographs of a cross section of a pellet doped with 0.25% by weight K₂O sintered at 1500° C. taken at magnifications of 1000× and 5000×, respectively.

FIGS. 4E and 4F are optical micrographs of a cross section of a pellet doped with 0.25% by weight K₂O sintered at 1550° C. taken at magnifications of 1000× and 5000×, respectively.

FIGS. 5A and 5B are an optical micrographs of a cross section of a pellet doped with 0.5% by weight K₂O sintered at 1450° C. taken at magnifications of 1000× and 5000×, respectively.

FIGS. 5C and 5D are optical micrographs of a cross section of a pellet doped with 0.5% by weight K₂O sintered at 1500° C. taken at magnifications of 1000× and 5000×, respectively.

FIGS. 5E and 5F are optical micrographs of a cross section of a pellet doped with 0.5% by weight K₂O sintered at 1550° C. taken at magnifications of 1000× and 5000×, respectively.

FIGS. 6A and 6B are optical micrographs of a cross section of a pellet doped with 1.0% by weight K₂O sintered at 1450° C. taken at magnifications of 1000× and 5000×, respectively.

FIGS. 6C and 6D are optical micrographs of a cross section of a pellet doped with 1.0% by weight K₂O sintered at 1500° C. taken at magnifications of 1000× and 5000×, respectively.

FIGS. 6E and 6F are optical micrographs of a cross section of a pellet doped with 1.0% by weight K₂O sintered at 1550° C. taken at magnifications of 1000× and 5000×, respectively.

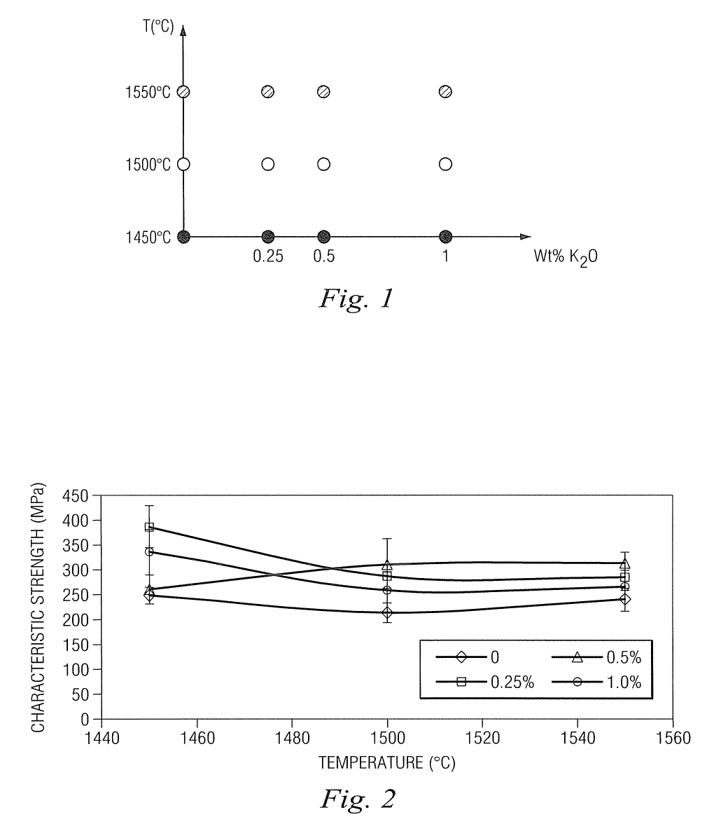

### DETAILED DESCRIPTION

Embodiments of the present invention relate to methods for producing sintered pellets and pellets made therefrom. The sintered pellets produced pursuant to the embodiments described herein can be used in a broad range of applications and are particularly useful as a proppant for subterranean formations.

Certain embodiments of the present invention relate to a method for producing sintered pellets including mixing a dopant with water and kaolin clay having more than 44 percent by weight aluminum oxide to form substantially round and spherical green pellets and sintering the pellets. The dopant is selected from the group consisting of potassium carbonate, potassium sulfate, potassium chloride, mica, kalsilite, and combinations thereof.

The dopant is added to the water and kaolin clay mixture in an amount effective to achieve sintered pellets having more than about 0.21 to about 3.0 percent by weight potassium oxide. Certain embodiments of the present invention include adding the dopant to the kaolin clay and water mixture in an amount effective to achieve more than about 0.2 to about 1.0 percent by weight potassium oxide, and, preferably, more than about 0.55 to about 1.06 percent by weight potassium oxide. In another embodiment, the dopant is added to the kaolin clay and water mixture in an amount effective achieve sintered pellets having more than about 0.91 to about 3.0 percent by weight potassium oxide. In yet another embodiment, the dopant is added to the kaolin clay and water mixture in an amount comprising about 1.06 to about 3.0 percent by weight potassium oxide. In still other embodiments the dopant is added to the kaolin clay and water mixture to achieve sintered pellets having a potassium oxide content in the following percent by weight ranges: from about 1.00 to about 3.00, from about 1.00 to about 2.00, from about 1.50 to about 3.00, from about 1.50 to about 2.00, from about 2.00 to about 2.50, and from about 2.50 to about 3.00.

Certain embodiments of the present invention provide sintered pellets that exhibit a specific strength exceeding 88 MPa-cc/g. In other embodiments, the specific strength of the sintered pellets is at least 91 MPa-cc/g.

In another embodiment, the sintered pellets exhibit characteristic strengths exceeding 248 MPa. In another embodiment, the sintered pellets have characteristic strengths of at least 258 MPa.

According to another embodiment, the dopant is potassium carbonate (K₂CO₃) added to the kaolin clay and water mixture in an amount of from about 0.19 to about 0.94 percent by weight potassium oxide. In certain embodiments, the potassium carbonate dopant is added to the kaolin clay and water mixture in an amount of from about 0.44 to about 0.94 percent by weight potassium oxide.

An embodiment of the invention, further includes blending a first kaolin clay having 46 percent by weight alumina and a second kaolin clay having 60 percent by weight alumina in amounts effective to produce a sintered pellet having at least 46 percent by weight aluminum. Alternatively, a first kaolin having 46 percent by weight alumina and a second kaolin clay having 60 percent by weight alumina are blended to achieve a sintered pellet having an alumina content of at least 48 percent by weight, at least 51 percent by weight, or at least 60 percent by weight.

Certain embodiments involve grinding the dopant and kaolin clay to an average particle size of less than about 15 microns. In other embodiments the dopant and kaolin clay have an average particle size of less than about 10 microns or less than about 5 microns. According to yet another embodiment, the method for producing sintered pellets includes grinding the dopant and kaolin clay to a particle size of about 0.2 microns to about 45 microns.

According to another embodiment, the method for producing sintered pellets includes sintering the pellets at a temperature from about 1300° C. to about 1600° C., from about 1400° C. to about 1500° C., or from about 1400° C. to about 1450° C.

Another embodiment provides a method for producing sintered pellets including mixing an effective amount of dopant selected from the group consisting of potassium carbonate, potassium sulfate, potassium chloride, mica, kalsilite, and combinations thereof with water and kaolin clay having at least 44 percent by weight aluminum oxide to form substantially round and spherical green pellets and sintering the pellets; wherein the sintered pellets exhibits a specific strength exceeding 88 MPa-cc/g. In other embodiments, the specific strength of the sintered pellets is at least 91 MPa-cc/g.

Certain other embodiments provide a method for producing sintered pellets having improved quantities of mullite and glass including mixing potassium carbonate with water and kaolin clay to form substantially round and spherical green pellets and sintering the pellets at temperatures between about 1400° C. to about 1450° C., and, preferably at about 1450° C. The potassium carbonate is added in an amount effective to achieve sintered pellets having more than about 0.02 to about 3.0 percent by weight potassium oxide and, preferably, more than 0.91 to about 3.0 percent by weight potassium oxide, and more preferably, at least 1.06 to about 3.0 percent by weight potassium oxide.

Kaolin clay is doped with a dopant of potassium carbonate, potassium sulfate, potassium chloride, mica, kalsilite, or combinations thereof to enhance low temperature densification. In addition to enhanced densification, the dopant improves formation of mullite, a crystalline phase that yields higher strength pellets. Enhanced densification and mullite formation at lower sintering temperatures facilitates more economic production of high specific strength pellets.

In some embodiments, substantially round and spherical green pellets are formed by a process that is referred to as “dry”, while in other embodiments, substantially round and spherical green pellets are formed by a process that is referred as “wet”.

As an example of a suitable “dry” process, the kaolin clay and the potassium oxide generating dopant are mixed with water to form a particulate mixture in a high intensity mixer. Suitable commercially available intensive stirring or mixing devices have a rotatable horizontal or inclined circular table and a rotatable impacting impeller, such as described in U.S. Pat. No. 3,690,622, to Brunner, the entire disclosure of which is incorporated herein by reference. Sufficient water is added to the mixture to cause formation of substantially round and spherical pellets. In general, the total quantity of water which is sufficient to cause substantially round and spherical pellets to form is from about 15 to about 30 weight percent of the particulate mixture. Those of ordinary skill in the art will understand how to determine a suitable amount of water to add to the mixer so that substantially round and spherical pellets are formed. In addition to the water and the particulate mixture, a binder may be added to the initial mixture to improve the formation of pellets and to increase the green strength of the unsintered pellets. Suitable binders include but are not limited to various resins or waxes, bentonite, corn starch, polyvinyl alcohol or sodium silicate solution, or a blend thereof. The amount of time to mix the water and the particulate mixture to form substantially round and spherical green pellets can be determined by visual observation of the pellets being formed, but is typically from about 2 to about 15 minutes.

“Dry” processes similar to the above-described “dry” process that are suitable for use with the methods described herein, and which are also known to those of ordinary skill in the art, include those described in U.S. Pat. No. 4,427,068; U.S. Pat. No. 4,879,181; U.S. Pat. No. 4,895,284; and U.S. Pat. No. 7,036,591 the entire disclosures of which are incorporated herein by reference.

An example of a suitable “wet” process is a fluid bed process, in which the kaolin clay and the potassium oxide generating dopant are added to form a particulate mixture, and mixed in a blunger (or similar device) with a sufficient amount of water to form a slurry having a solids content in the range of from about 40 to about 60 percent by weight. Those of ordinary skill in the art will understand how to determine a sufficient amount of water to form a slurry having a solids content in the range of from about 40 to about 60 percent by weight. Those of ordinary skill in the art also understand slurry manufacturing, and therefore understand that the amount of water mixed with the particulate mixture in a “wet” process is greater than the amount of water mixed with the particulate mixture in a “dry” process. Generally, slurry processing requires a combination of water and solids (raw materials) that behaves like a liquid, while dry processing requires a combination of water and solids (raw materials) that behave like a solid. A binder may be added to the initial mixture to improve the formation of pellets and to increase the green strength of the unsintered pellets. Suitable binders include but are not limited to polyvinyl acetate, polyvinyl alcohol (PVA), methylcellulose, dextrin and molasses. In addition, one or more of a dispersant, a pH-adjusting reagent, and a defoamer can be added to the slurry in the blunger. A binder may be added to the slurry in the blunger or the slurry may be fed from the blunger to a separate tank prior to the addition of the binder.

Dispersants and pH-adjusting reagents can be added to adjust the viscosity of the slurry so as to achieve a target viscosity. A target viscosity is that viscosity that can be processed through a given type and/or size of the pressure nozzle of a subsequent fluidizer, without becoming clogged. Generally, the lower the viscosity of the slurry, the better it can be processed through a given fluidizer. However, at some concentration of dispersant, the dispersant can cause the viscosity of the slurry to increase to a point that it cannot be satisfactorily processed through a given fluidizer. One of ordinary skill in the art can determine the appropriate amount of dispersant and the target viscosity for given fluidizer types through routine experimentation. If a pH-adjusting reagent is used, then the amount of pH-adjusting reagent added to the slurry should be that amount which gives the slurry a pH in the range of from about 8 to about 11. Selection of a suitable dispersant or pH-adjusting reagent to achieve a target viscosity and/or pH can be made by those of ordinary skill in the art through routine experimentation.

A defoamer can be added to the slurry in the blunger to reduce or prevent equipment problems caused by foaming of the slurry. Those of ordinary skill in the art can identify and select a suitable type and amount of defoamer to use in the processes described herein through routine experimentation.

From the blunger, or if a binder is used, a separate tank, the slurry is fed to a heat exchanger, which heats the slurry to a temperature in a range of from about 25° C. to about 90° C. From the heat exchanger, the slurry is fed to a pump system, which feeds the slurry, under pressure, to a fluidizer. By virtue of the blunger, and/or the stirring occurring in the tank, any particles in the slurry are reduced to a target size of less than about 230 mesh so that the slurry can be fed to the fluidizer without clogging of the fluidizer nozzles or other equipment problems. The target size of the particles is influenced by the ability of the type and/or size of the pressure nozzle in the subsequent fluidizer to atomize the slurry without becoming clogged. In some embodiments, the slurry may be fed through either or both of a grinding mill(s) and/or a screening system(s) to assist in breaking down and/or removing any larger-sized material to a size suitable for feeding to the fluidizer.

Heat exchangers, pump systems and fluidizers, and their methods of operation, are known to those of ordinary skill in the art, and therefore need not be detailed herein. However, a general description of a fluidizer suitable for use with the methods described herein is provided for the convenience of the layperson. The fluidizer has one or more atomizing nozzles, and a particle bed comprised of “seeds”. The slurry is sprayed, under pressure, through the atomizing nozzles, and the slurry spray coats the seeds in the particle bed.

Hot air is introduced into the fluidizer, and passes through the particle bed at a velocity in a range of from about 0.9 to about 1.5 meters/second, and the depth of the particle bed is in a range of from about 2 to about 60 centimeters. The temperature of the hot air when introduced to the fluidizer is in a range of from about 250° C. to about 650° C. The temperature of the hot air as it exits from the fluidizer is less than about 250° C. or less than about 100° C. Substantially round and spherical green pellets accumulate in the particle bed, and are withdrawn through an outlet in response to the level of product in the particle bed, so as to maintain a given depth in the particle bed. The substantially round and spherical green pellets withdrawn from the particle bed can be separated into one or more fractions, for example, an oversize fraction, a product fraction, and an undersize fraction. Undersized and oversized fractions can be recycled into the slurry, and the substantially round and spherical green pellets comprising the product fraction can be subjected to sintering operation with or without drying. In certain embodiments, the particles are dried prior to sintering operation to a moisture content of less than about 18 percent by weight, less than about 15 percent by weight, less than about 12 percent by weight, less than about 10 percent by weight, less than about 5 percent by weight, or less than about 1 percent by weight. If the substantially round and spherical green pellets are dried prior to sintering operation, then such drying may also comprise partially calcining or calcining the substantially round and spherical green pellets.

“Wet” processes similar to the above-described “wet” process that are suitable for use with the methods described herein, and which are also known to those of ordinary skill in the art, include those described in U.S. Pat. No. 4,440,866 and U.S. Pat. No. 5,120,455, the entire disclosures of which are incorporated herein by reference.

Another example of a suitable “wet” process for forming substantially round and spherical green pellets is a spray drying process, in which the kaolin clay and the potassium oxide generating dopant are added to form a particulate mixture, and mixed in a blunger (or similar device) with a sufficient amount of water to form a slurry having a solids content in the range of from about 50 to about 75 percent by weight. Those of ordinary skill in the art will understand how to determine a sufficient amount of water to form a slurry having a solids content in the range of from about 50 to about 75 percent by weight.

In addition, one or more of a dispersant, a defoamer, and a binder can be added to the slurry in the blunger. A defoamer can be added to the slurry in the blunger to reduce or prevent equipment problems caused by foaming of the slurry. Those of ordinary skill in the art can identify and select a suitable type and amount of defoamer to use in the processes described herein through routine experimentation.

Suitable dispersants include but are not limited to colloids, polyelectrolytes, tetra sodium pyrophosphate, tetra potassium pyrophosphate, polyphosphate, ammonium citrate, ferric ammonium citrate, and sodium hexametaphosphate. In a spray drying process, dispersant can be added to adjust the viscosity of the slurry so as to achieve a target viscosity for the spray drying equipment being used. In addition, in a spray drying process, dispersant can affect the ability to form “solid” substantially round and spherical pellets, and therefore the amount of dispersant, if any, to include in the slurry is minimized, as will be discussed further herein.

Suitable binders include but are not limited to polyvinyl alcohol, polyvinyl acetate, methylcellulose, dextrin and molasses. Binder may be added to the slurry in the blunger or the slurry may be fed from the blunger to a separate tank prior to the addition of the binder. If binder is added to the slurry in the blunger, then the mixing speed of the blunger may be reduced prior to addition of the binder so as to reduce or prevent excessive foaming and/or viscosity increases that may occur. In a spray drying process, the addition of a binder to the slurry can affect the ability to form “solid” substantially round and spherical pellets, and therefore the amount of binder/dispersant, if any, to include in the slurry is minimized, as will be discussed further herein.

Whether binder, if any, is added to the slurry in the blunger or in a separate tank, the slurry is continually stirred, after addition of the binder, for an amount of time sufficient to allow for the binder to become thoroughly mixed throughout the slurry. In certain embodiments, the amount of time the slurry is stirred is up to about 30 minutes or more after the binder has been added.

From the blunger, or if a binder is used, a separate tank, the slurry is fed to a spray drying apparatus comprising atomizing equipment and a drying chamber. Suitable atomizing equipment includes but is not limited to a rotary wheel atomizer, a pressure nozzle atomizer and a dual fluid nozzle atomizer, all of which are known to those of ordinary skill in the art. Generally, rotary wheel atomizers produce fine particles, while pressure nozzles and dual fluid nozzles operated under pressure can produce comparatively larger particles.

The atomizing equipment sprays the slurry into the drying chamber, where droplets of slurry meet hot air in a drying chamber. The droplets and hot air move through the drying chamber as a generally co-current flow, counter-current flow, or a combination thereof. For example, in a combination of co-current and counter-current flow, slurry droplets are sprayed from the atomizing equipment in an upward direction into the drying chamber, while hot air is fed into the drying chamber from a point above the point at which the slurry is sprayed into the drying chamber. Thus, the hot air flows in a generally downward direction in the chamber with respect to the slurry droplets. The upward flow of the slurry droplets and the downward flow of the hot air establish a counter-current flow. At some point, however, the droplets will exhaust their upward trajectory, and begin to flow in a generally downward direction in the chamber, thereby establishing a co-current flow with the hot air. Alternatively, slurry droplets are sprayed into the drying chamber in a generally downward direction, and the hot air is fed into the drying chamber in a generally downward direction as well, thereby establishing a co-current flow. The cylindrical height of the drying chamber influences the pellet size. For example, the height of drying chamber is estimated to be 19.8 meters for making 30/50 sized pellets (approximately an average green pellet size of 765 microns). In the drying chamber, solid substantially round and spherical green pellets form as moisture is evaporated from the droplets. As used herein, a “solid” substantially round and spherical pellet describes a pellet having an interior void that is less than about 10 percent by volume of the particle. In certain embodiments, solid substantially round and spherical pellets could have an interior void that is less than about 5 percent by volume of the pellet. Because the droplets generally do not rotate as they are projected through the drying chamber, one side of the droplet can be exposed to air from the inlet that is hotter than the air to which the other side of the droplet is exposed (referred to herein as the “hot side” and the “cool side”, respectively). In such instances, evaporation is faster on the hot side, and the film that forms on the surface of the droplet thickens more rapidly on the hot side than on the cool side. Liquid and solids in the droplet migrate to the hot side. At this point, it would be expected that the cool side would be drawn inward, which would result in a hollow green particle with a dimple, rather than the solid substantially round and spherical green pellets described herein. However, according to the methods described herein, the pellets are solid rather than hollow because of one or more of the following factors: solids content in the weight percents described herein, solubles content (dispersant and/or binder) in the weight percents described herein, and air inlet temperatures in the ranges as described herein.

Regarding the solids content, slurries having solids contents greater than about 50 weight percent are used to produce solid substantially round and spherical particles as described herein. In certain embodiments, the slurry has a solids content in the range of from about 50 to about 75 percent by weight, while in other embodiments, the slurry has a solids content in the range from about 50 to about 60 percent by weight, or from about 60 to about 70 percent by weight.

Regarding the solubles content, binders increase slurry viscosity, which can lead to the need to reduce the solids content in order to maintain a slurry that can be atomized. A lower solids content, however, can lead to a particle that is not solid. As for dispersants, dispersants allow more rapid movement of solids to the surface of the particle, which can also lead to a particle that is not solid. Thus, the solubles content in a slurry (amounts of additives such as binders and dispersants) is balanced against the solids content of the slurry. Preferably, the least amount of binder and/or dispersant, as determined by the need to adjust viscosity of the slurry, is used.

Regarding the air inlet temperatures, the temperature of the air entering a drying chamber is controlled according to methods described herein. Thus, in certain embodiments, the air inlet temperature is in a range from about 100° C. to about 400° C. Preferably, temperatures in the lower end of such ranges are used in order to slow the rate of drying of the particles, which in turn contributes to the production of substantially round and spherical green pellets that can be sintered to produce solid ceramic pellets that are substantially round and spherical.

Thus, in a spray drying process, solid substantially round and spherical green pellets are discharged from the drying chamber at least in part under the influence of gravity. The solid substantially round and spherical green pellets can then be subjected to sintering operation.

Substantially round and spherical green pellets produced by either a “wet” or “dry” process are sintered to their final form. Sintering can be performed in a rotary kiln, a box kiln, or other suitable device that can provide appropriate sintering conditions. Sintering and equipment to perform sintering are known to those of ordinary skill in the art. In certain embodiments, sintering is performed at a temperature in the range of from about 1200° C. to about 1550° C. for a time in the range of from about 20 to about 45 minutes at peak temperature.

The following example is provided for illustration and not limitation.

### EXAMPLE

Blends of varying concentrations of a potassium carbonate (K₂CO₃) dopant and kaolin clay having 46 and 60 percent by weight of alumina (Al₂O₃) were sintered at various temperatures. Kaolin clays having 46 and 60 percent by weight alumina were blended to result in a final concentration of 48 percent by weight alumina. The K₂CO₃ is commercially available from Alfa Aesar as Potassium Carbonate ACS. The kaolin clay is commercially available from CE Minerals of Andersonville, Ga. as calcined kaolin clay (“CK-46”) having 46 percent by weight alumina and raw kaolin clay (“K-60”) having 60 percent by weight alumina.

Substantially round and spherical pellets were made from four blends and were tested. The four blends were designated as an undoped blend (A), 0.25% by weight K₂O blend (B), 0.5% by weight K₂O blend (C), and 1.0% by weight K₂O blend (D). Kaolin naturally contains a trace amount of K₂O, which results in the undoped pellets having about 0.06% by weight of K₂O. The undoped blend (A) was made from a mixture of 96.05% by weight of the 46% alumina kaolin and 3.95% by weight of the 60% alumina kaolin. The 0.25% by weight K₂O blend (B) was made from a mixture of 95.11% by weight of the 46% alumina kaolin, 4.70% by weight the 60% alumina kaolin, and 0.19% by weight K₂CO₃. The 0.5% by weight K₂O blend (C) was made from a mixture of 93.86% by weight of the 46% alumina kaolin, 5.70% by weight of the 60% alumina kaolin, and 0.44% by weight K₂CO₃. The 1.0% by weight K₂O blend (D) was made from a mixture of 91.41% by weight of the 46% alumina kaolin, 7.65% by weight of the 60% alumina kaolin, and 0.94% by weight K₂CO₃.

The kaolin and potassium carbonate were combined and ground to a fine powder (approximately 10 microns) in a jet mill (Sturtevant Inc. 4″ Open Manifold Micronizer) using a feed rate of about one pound per hour. Kaolin and K₂CO₃ blends were added to an Eirich mixer to make pellets. The Eirich mixer has a circular table that can be horizontal or inclined between 0 and 35 degrees from horizontal, and can rotate at a speed of from about 10 to about 60 revolutions per minute (rpm). The mixer also has a rotatable impacting impeller that can rotate at a tip speed of from about 5 to about 50 meters per second. The direction of rotation of the table is opposite that of the impeller, which causes material added to the mixer to flow over itself in countercurrent manner. The central axis of the impacting impeller is generally located within the mixer at a position off center from the central axis of the rotatable table.

The table of the Eirich mixer was rotated at from about 20 to about 40 rpm, at an incline of about 30 degrees from horizontal. The impacting impeller was initially rotated at about 25-35 meters per second (about 1014-1420 rpm). The speed of the impacting impeller was increased, and water was added to the mixer as described below.

Water was added to the mixer in an amount sufficient to cause formation of substantially round and spherical pellets. In this particular example, the water was fresh tap water, which was added to the mixer in an amount sufficient to provide a percentage, based on the weight of the kaolin clay and K₂CO₃ blend in the mixer, from about 18 to about 22 percent by weight, although this amount can vary. In general, the quantity of water used in the present method is that amount which is sufficient to cause substantially round and spherical pellets to form upon mixing.

The rate of water addition to the mixer is not critical. The intense mixing action disperses the water throughout the mixture. During the addition of the first half of the amount of water, the impacting impeller was rotated at about 16 meters per second (about 568 rpm), and was thereafter rotated at a higher tip speed of about 32 meters per second (about 1136 rpm). The initial rotation of the impeller is optional. If employed, the initial rotation is from about 5 to about 20 meters per second, followed by a higher tip speed in a range of from about 25 to about 30 meters per second. Those of ordinary skill in the art can determine whether to adjust the rotation speed of the impeller and/or pan to values greater than or less than those described above such that substantially round and spherical pellets are formed.

The kaolin clay and K₂CO₃ were mixed with water for about 2 to 6 minutes to achieve the formation of substantially round and spherical pellets of a target green pellet size. Trim dust, which has the same composition as the corresponding blend, was added to the mixer to facilitate pellet formation and to coat the pellets. The amount of mixing time needed to form such pellets varies depending upon a number of factors, including but not limited to the amount of material in the mixer, the speed of operation of the mixer, the amount of water added to the mixer, and the target green pellet size.

The substantially round and spherical green pellets were discharged from the mixer and dried. The pellets were dried in a drying oven at 110° C., resulting in dried green pellets having a moisture content of less than about 1 percent by weight. The pellets are referred to as “green” after removal from the dryer because they have not been sintered to their final state. The pellets were sieved to isolate pellets having the target green pellet size of between about 16 to about 40 mesh.

The green pellets were loaded into a box kiln and heated at a rate of 16° C./min to achieve various firing temperatures of 1450° C., 1500° C., and 1550° C. and were held at peak temperature for 30 minutes.

The measured chemistries for the ground green pellet blends are shown below in Table 1.

TABLE 1

| | A | B | C | D |
|---|---|---|---|---|
| Al₂O₃ | 48.15 | 48.08 | 48.24 | 48.31 |
| SiO₂ | 48.48 | 48.38 | 47.82 | 47.28 |
| Fe₂O₃ | 1.00 | 0.96 | 0.99 | 0.99 |
| TiO₂ | 2.10 | 2.12 | 2.20 | 2.16 |
| CaO | 0.04 | 0.04 | 0.04 | 0.04 |
| K₂O | 0.07 | 0.27 | 0.55 | 1.06 |
| MgO | 0.04 | 0.04 | 0.03 | 0.04 |
| MnO | NA | NA | NA | NA |
| Na₂O | 0.03 | 0.03 | 0.04 | 0.03 |
| P₂O₅ | 0.04 | 0.04 | 0.04 | 0.04 |

Chemistries of the experimental blends were measured by inductively coupled plasma with optical emission spectroscopy (ICP-OES). Crystalline phase assemblages of the raw and sintered experimental blends were identified and quantified through X-ray diffraction (XRD) while glass content was determined through an acid dissolution technique. Sintered samples have been evaluated for true and apparent densities using helium pycnometry. Micrographs, collected with an environmental scanning electron microscope (ESEM), revealed varying grain morphologies and pore distributions. These results, regarding crystalline phase evolution, densification, and microstructure, were correlated with strength distributions collected by diametral compression of individual pellets. Dramatic variations in strength, density, and specific strength were observed in both material systems as dopant concentrations and sintering temperatures were varied.

Table 2 shows the results of a semi-quantitative phase analyses of the sintered material as a function of sintering temperatures as determined by XRD (“NA” indicates that diffraction peaks were not detected from diffractogram and “Tr” indicates that peaks were observed but were too small to quantify).

TABLE 2

| | A | B | C | D |
|---|---|---|---|---|
| 1450° C. | | | | |
| Mullite | 75 | 77 | 81 | 100 |
| Cristobalite | 25 | 23 | 19 | NA |
| Quartz | Tr | NA | NA | NA |
| Rutile | Tr | NA | NA | NA |
| Pseudobrookite | NA | NA | NA | NA |
| 1500° C. | | | | |
| Mullite | 76 | 92 | 100 | 100 |
| Cristobalite | 24 | 8 | Tr | NA |
| Quartz | NA | NA | NA | NA |
| Rutile | NA | NA | NA | NA |
| Pseudobrookite | NA | NA | NA | NA |
| 1550° C. | | | | |
| Mullite | 100 | 100 | 100 | 100 |
| Cristobalite | NA | NA | NA | NA |
| Quartz | NA | NA | NA | NA |
| Rutile | NA | NA | NA | NA |
| Pseudobrookite | NA | NA | NA | NA |

Comparing the phase assemblages of the sintered material made from the doped blends to the phase assemblages of the sintered material made from the undoped blend (A), it can be seen that sintered material made from the K₂O-doped kaolinite blends (B, C, D) appear to contain a greater amount of mullite than sintered material made from the undoped blend (A). The dopant appears to enhance mullite formation and suppress cristobalite formation.

In addition to the crystalline content, the glass content of the doped kaolinite was analyzed. There is a subtle trend that indicates that the K₂O-doped kaolinite blends (B, C, D) exhibit increasing glass content with increasing K₂O concentration. Table 3 shows the glass contents of the blends as a function of sintering temperature.

TABLE 3

| Blend # | 1450° C. | 1500° C. | 1550° C. |
|---|---|---|---|
| A | 11 | 8 | 14 |
| B | 13 | 11 | 14 |
| C | 12 | 14 | 16 |
| D | 14 | 11 | 16 |

Referring to Tables 2 and 3, the sintered material doped with the 1% blend (D) exhibits enhanced mullite and glass formation at lower sintering temperatures. The sintered material made from the 1.0% by weight K₂O blend (D) sintered at 1450° C. surprisingly achieved 100% mullite formation. Additionally, glass formation was unexpectedly enhanced at lower sintering temperatures in the material doped with the 1% blend (D). A sintered material doped to achieve more than about 0.91 percent by weight K₂O and, preferably, more than about 1.00 percent by weight K₂O surprisingly yields improved quantities of mullite and glass at lower sintering temperatures, such as 1400° C. to 1450° C., and preferably, about 1450° C.

Pycnometric density measurements of the blends as a function of sintering temperature are detailed in Table 4 below.

TABLE 4

| | 1450° C. | | | 1500° C. | | | 1550° C. | | |
|---|---|---|---|---|---|---|---|---|---|
| | | | Relative | | | Relative | | | Relative |
| Formula | Apparent | True | Density | Apparent | True | Density | Apparent | True | Density |
| A | 2.78 | 2.83 | 0.98 | 2.79 | 2.88 | 0.97 | 2.76 | 2.87 | 0.96 |
| B | 2.80 | 2.85 | 0.98 | 2.78 | 2.85 | 0.98 | 2.77 | 2.84 | 0.98 |
| C | 2.81 | 2.80 | 1.00 | 2.78 | 2.86 | 0.97 | 2.77 | 2.82 | 0.98 |
| D | 2.76 | 2.77 | 1.00 | 2.78 | 2.85 | 0.98 | 2.77 | 2.86 | 0.97 |

Apparent density, which is obtained by performing helium pycnometry on entire pellets, includes the volume of the solid phase as well as any enclosed porosity. True density, on the other hand, is obtained via helium pycnometry of ground (<150 μm) powders, and is assumed to include only the volume of the solid phase since grinding is expected to eliminate internal porosity. All density measurements in Table 4 are in g/cc.

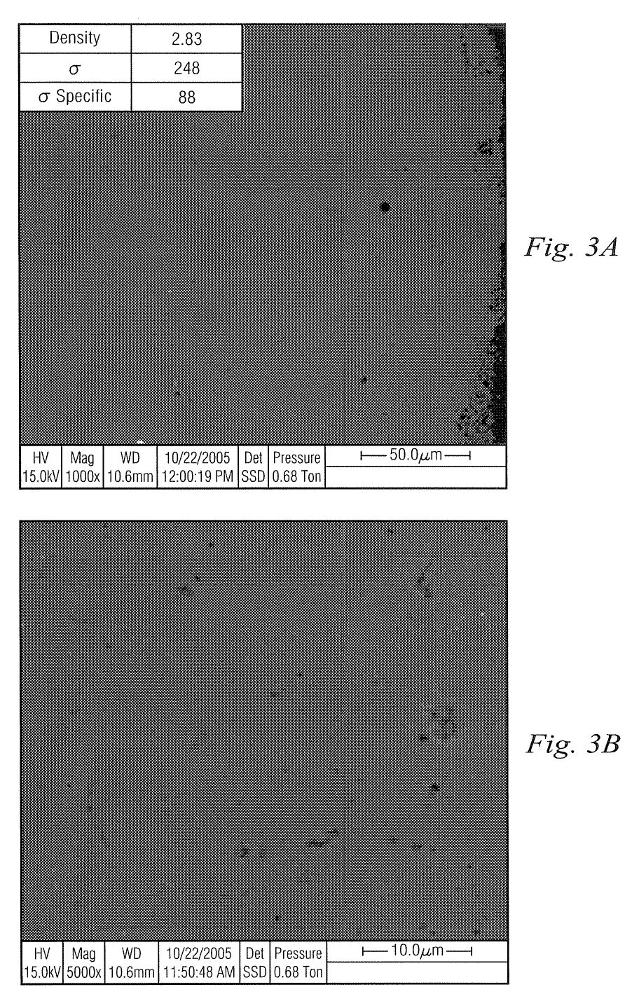

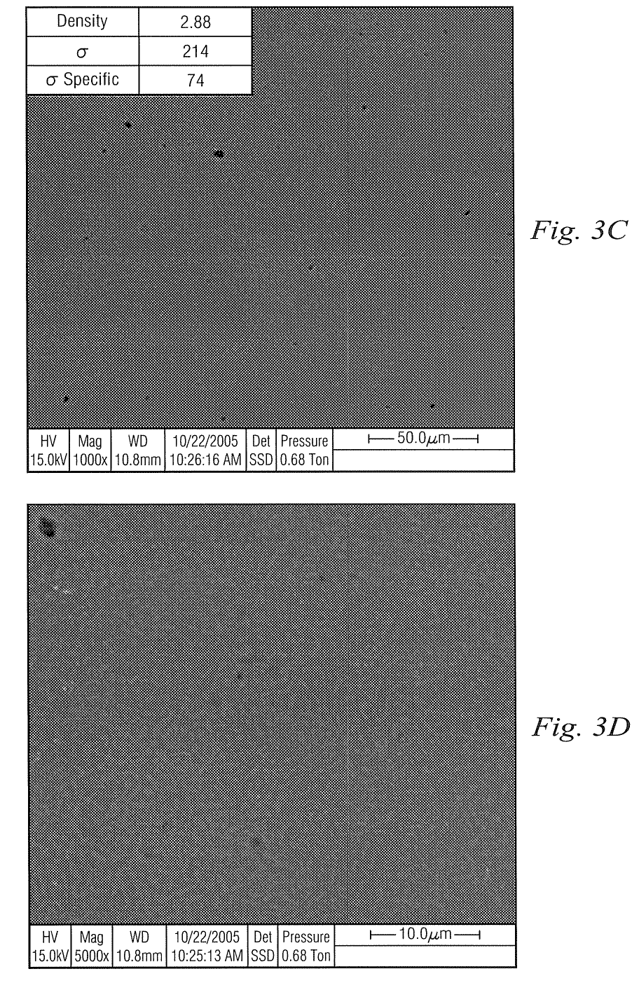

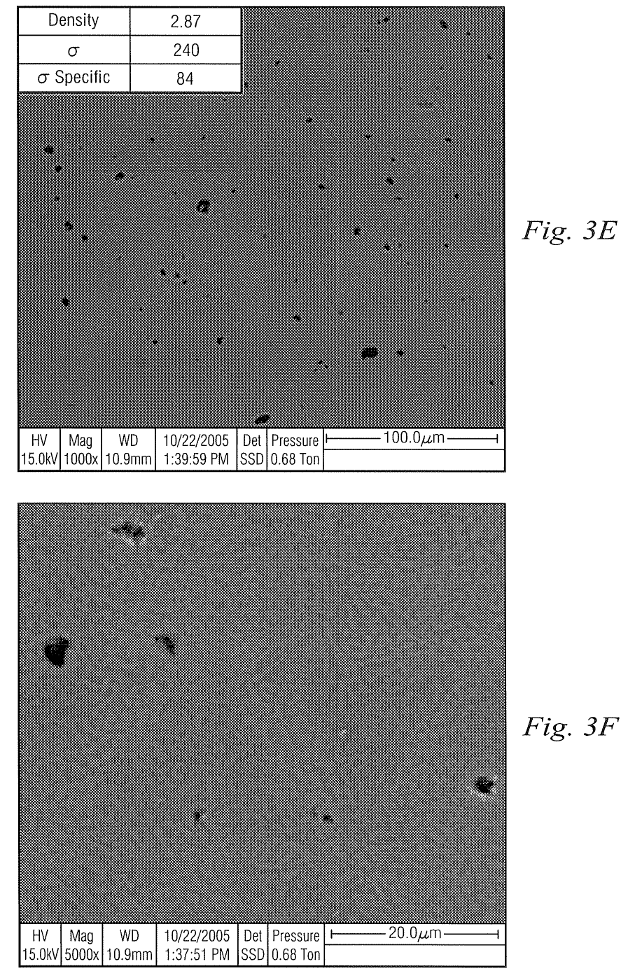

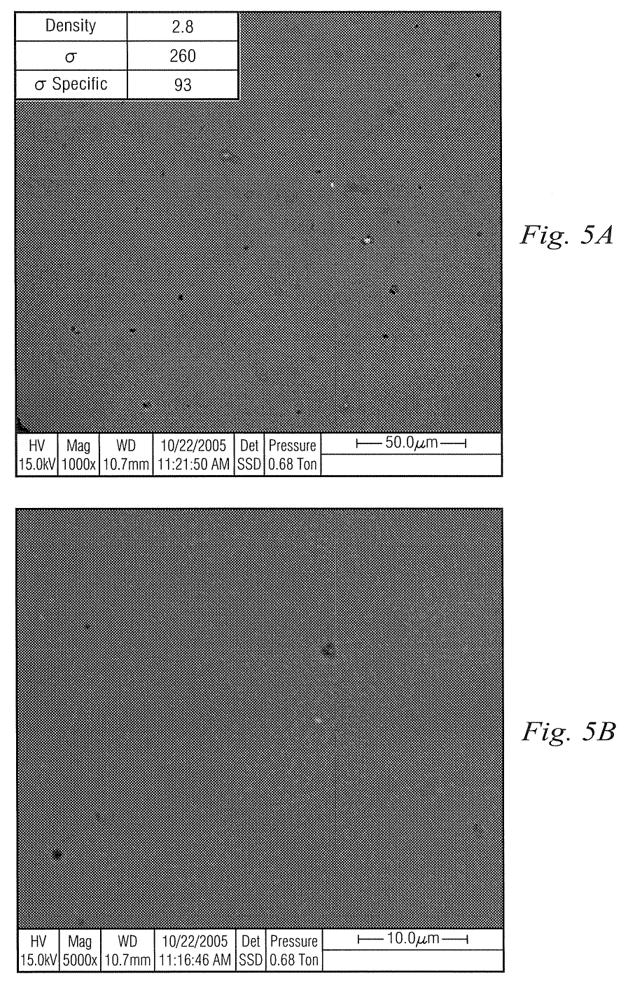

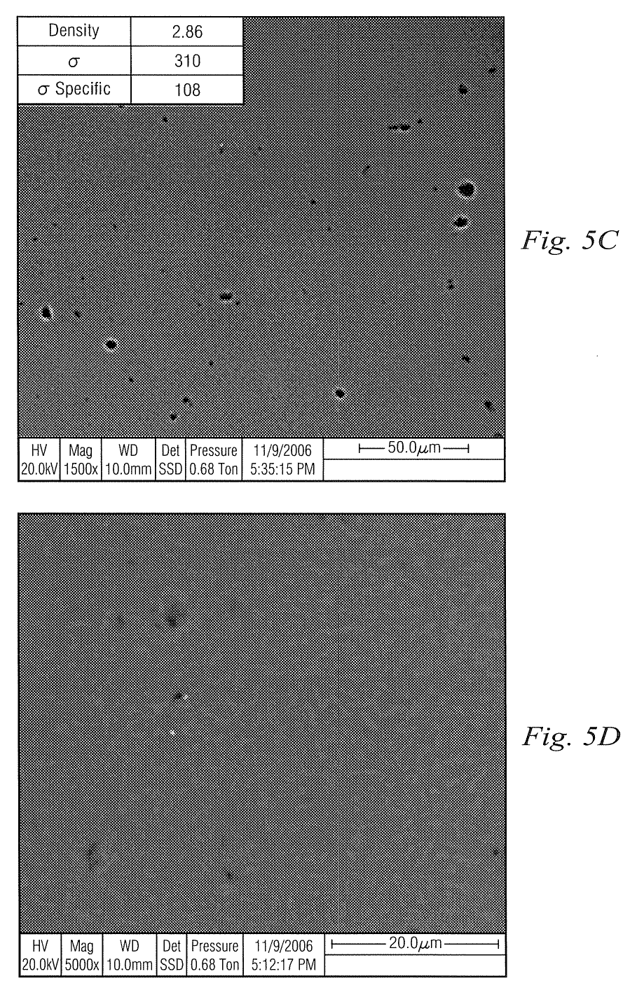

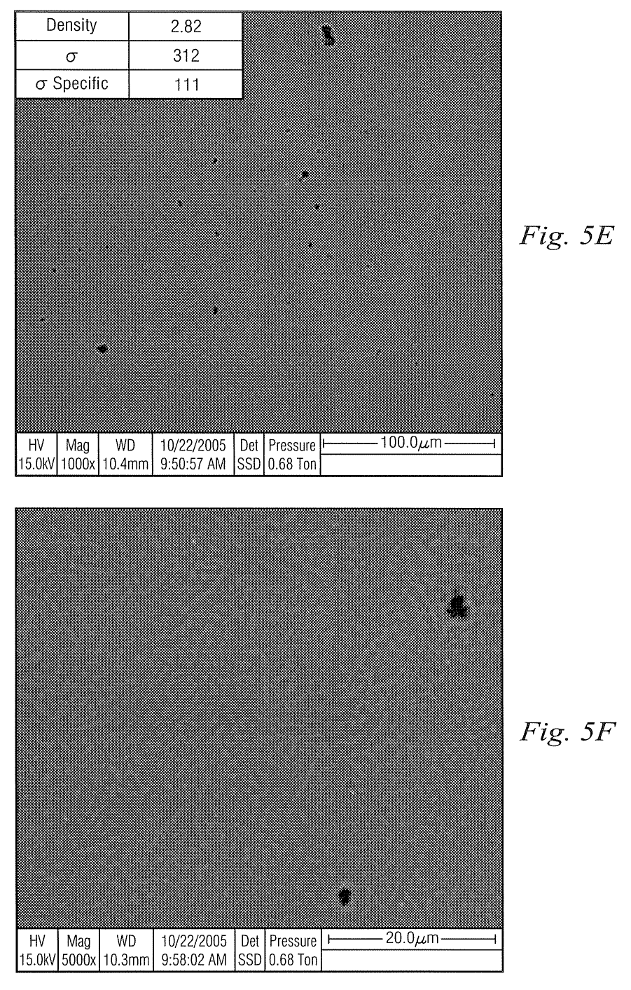

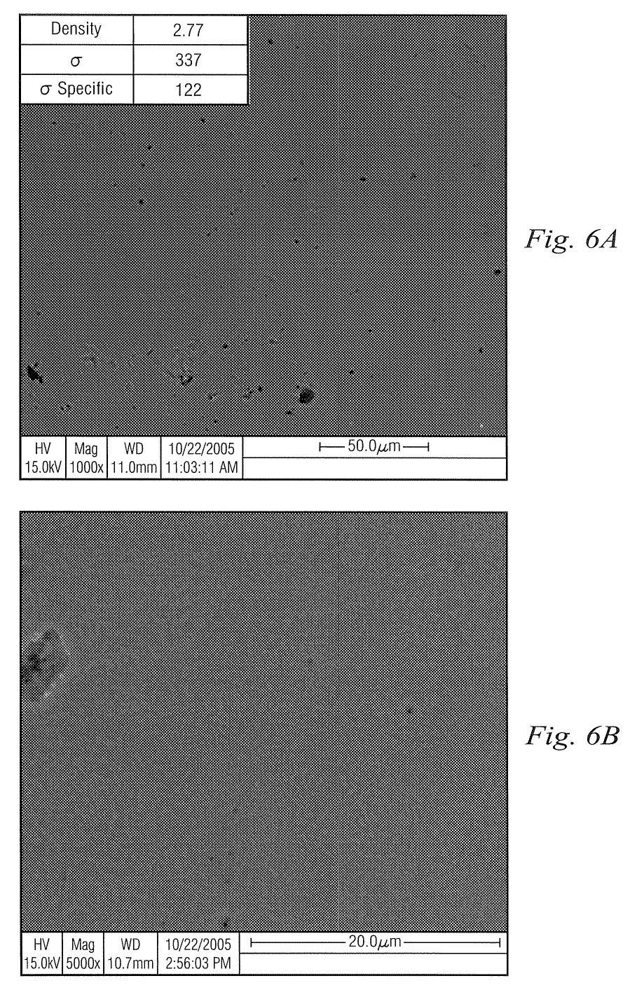

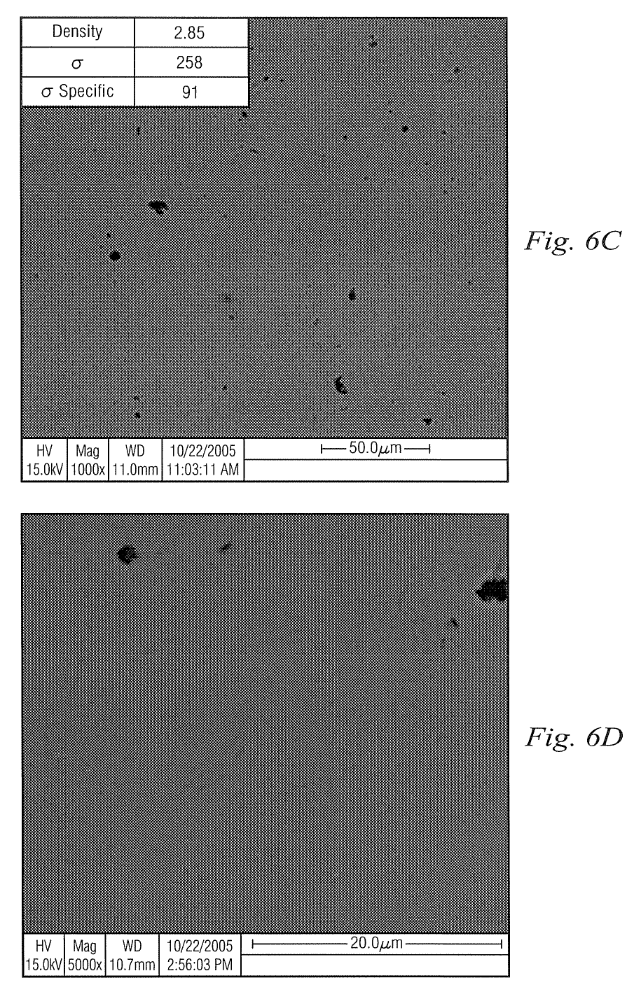

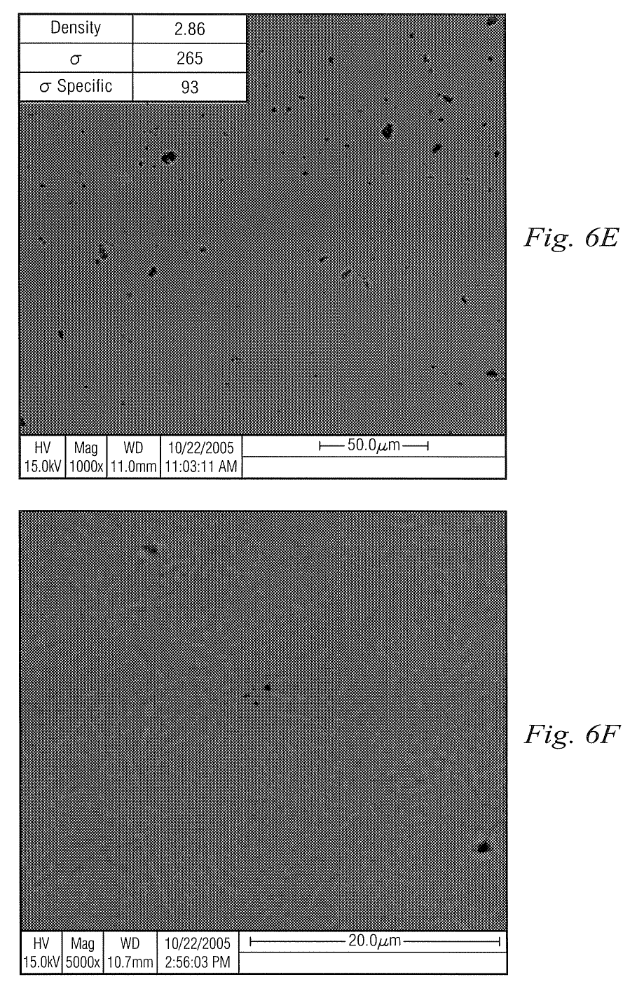

Back-scattered electron (BSE) micrographs of each experimental blend are presented in FIGS. 3A-6F. Images were taken at high and low magnification for comparison and reveal many interesting trends regarding microstructural evolution as a function of dopant concentration and sintering temperature.

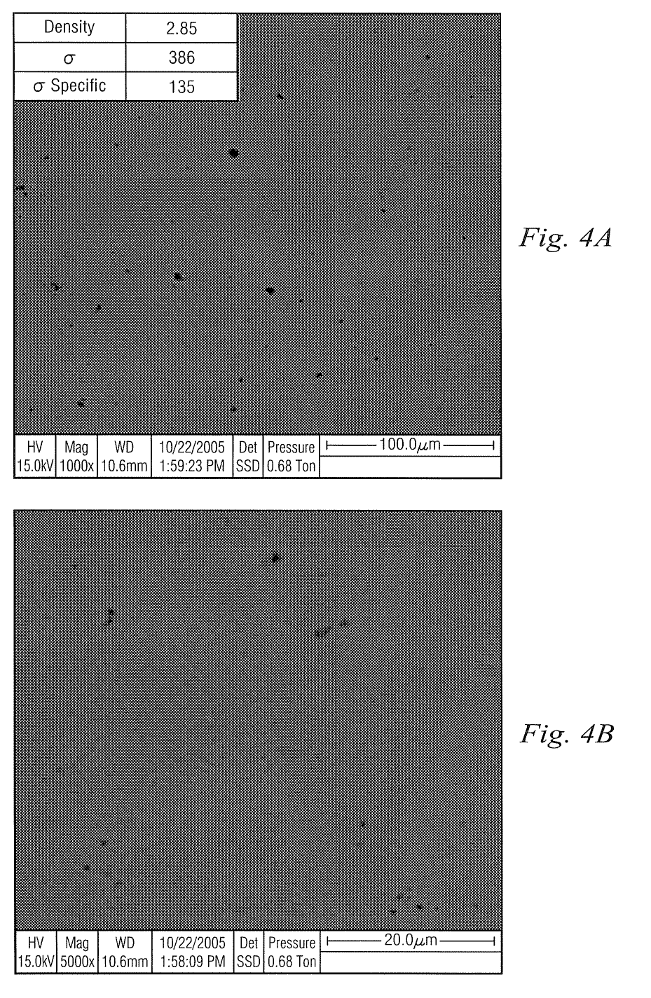

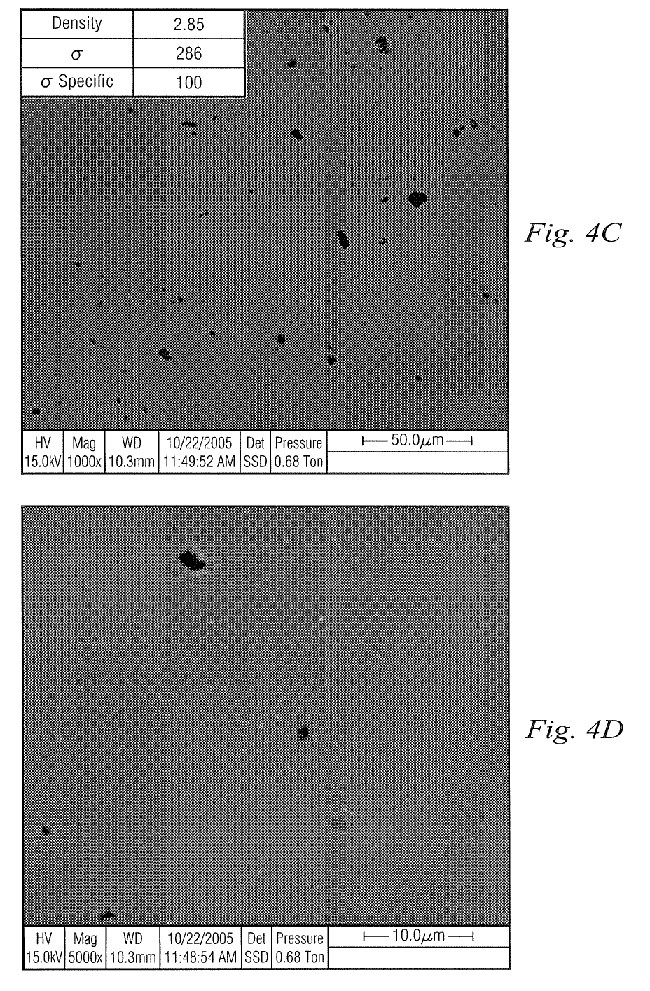

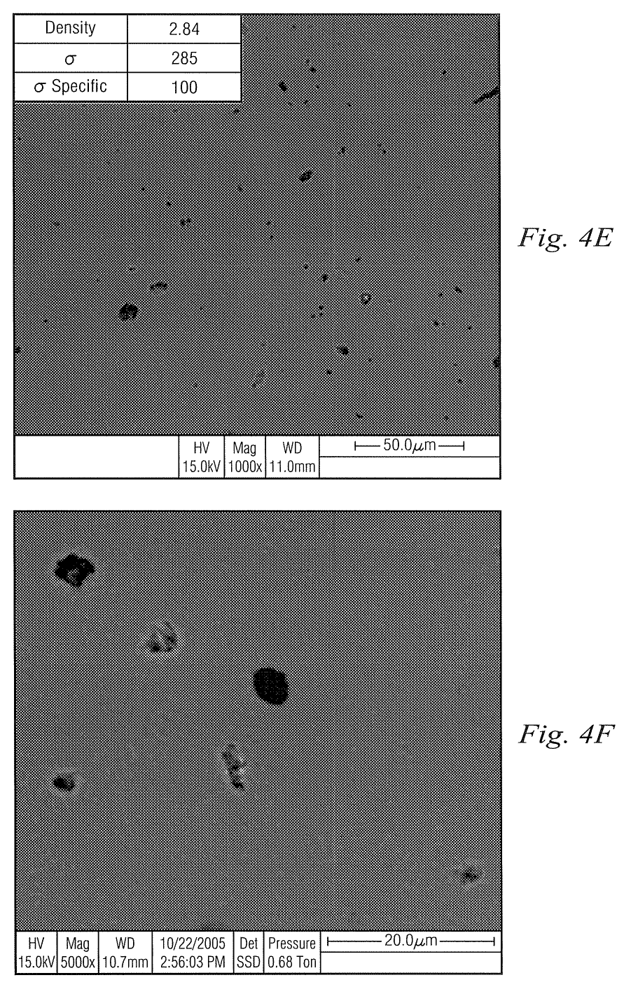

The K₂O-doped blends (B, C, D) shown in FIGS. 4A-6F contain pores of similar size and distribution as the undoped blend (A) shown in FIGS. 3A-3F at different sintering temperatures. However, the fine, interpenetrated microstructure that appears in each experimental blend appears coarser with increasing K₂O content.

The strength responses and densities of the blends are presented in FIG. 2 and Table 5. Strengths (shown as Σ in Table 5) were determined by diametral compression of individual pellets between two non-compliant silicon carbide platens. Strength distributions were plotted and analyzed using Weibull Statistics and fitted with a maximum likelihood estimator to determine the Weibull parameters of characteristic strength and Weibull modulus. Strengths and specific strengths based on true density measurements were also calculated. Specific strength (shown as a Specific in Table 5) is the material strength divided by its density.

It can be seen that minor additions of K₂O lead to significant strength enhancement at the lowest sintering temperature (1450° C.). However, the strength responses of the blends (B, C, D) decline slightly and level off with increasing firing temperature. Overall, elevated K₂O contents do not adversely affect the strengths of kaolinite-derived pellets as one skilled in the art would expect. Instead, K₂O doping surprisingly facilitates the production of kaolinite-derived pellets with high specific strengths produced at lower sintering temperatures.

The K₂O-doped blends (B, C, D) exhibited high strength (a) and low density (p) as shown in Table 5, where specific strength (a Specific) is defined as (v)/(p).

TABLE 5

| | | 1450° C. | 1500° C. | 1550° C. |
|---|---|---|---|---|
| A | Density (g/cc) | 2.83 | 2.88 | 2.87 |
| Undoped | Σ (MPa) | 248 | 214 | 240 |
| | σ Specific (MPa-cc/g) | 88 | 74 | 84 |
| B | Density (g/cc) | 2.85 | 2.85 | 2.84 |
| 0.25% K₂O | Σ (MPa) | 386 | 286 | 285 |
| | σ Specific (MPa-cc/g) | 135 | 100 | 100 |
| C | Density (g/cc) | 2.8 | 2.86 | 2.82 |
| 0.5% K₂O | Σ (MPa) | 260 | 310 | 312 |
| | σ Specific (MPa-cc/g) | 93 | 108 | 111 |
| D | Density (g/cc) | 2.77 | 2.85 | 2.86 |
| 1% K₂O | Σ (MPa) | 337 | 258 | 265 |
| | σ Specific (MPa-cc/g) | 122 | 91 | 93 |

As discussed above, K₂O, which is considered an impurity that is typically associated with strength degradation when concentrations exceed 0.21 percent by weight, is an effective fluxing agent for kaolinite ores, particularly for the silica therein. Pellets made from K₂O-doped blends (B, C, D) show enhanced mullite formation (mullitization) through rapid ionic transport in low viscosity glass phase and enhanced densification via viscous sintering (ηₛᵢₙₜₑᵣ). K₂O-doped pellets as described above exhibit surprisingly enhanced strength at lower sintering temperatures.

Still referring to Table 5, the sintered material doped with the 1% blend (D) exhibits improved strengths at lower sintering temperatures. The sintered material made from the 1% blend (D) sintered at 1450° C. has surprisingly higher tensile and specific strengths as compared to the pellets of the same composition sintered at 1500° C. and 1550° C. A sintered material doped to achieve more than about 0.91 percent by weight K₂O and, preferably, more than about 1.00 percent by weight K₂O surprisingly exhibits improved strength at lower sintering temperatures, such as 1400° C. to 1450° C., and preferably, about 1450° C.

The pellets made from the K₂O doped blends (B, C, D) produced according to the methods described herein exhibit subtle microstructure coarsening, full mullitization, and increased strength.

It will be obvious to those skilled in the art that the invention described herein can be essentially duplicated by making minor changes in the material content or the method of manufacture. To the extent that such material or methods are substantially equivalent, it is intended that they be encompassed by the following claims.

1. A method for producing sintered pellets comprising:
mixing a dopant selected from the group consisting of potassium carbonate, potassium sulfate, potassium chloride, mica, kalsilite, and combinations thereof with water and kaolin clay having more than 44 percent by weight aluminum oxide to form substantially round and spherical green pellets and
sintering the pellets;
wherein the dopant is added in an amount effective to achieve sintered pellets comprising more than about 0.21 to about 3.0 percent by weight potassium oxide.

2. The method of claim 1 wherein the sintered pellets exhibit a specific strength exceeding 88 MPa-cc/g.

3. The method of claim 1 wherein the dopant is potassium carbonate added to the water and kaolin in an amount of from about 0.19 to about 0.94 percent by weight potassium oxide.

4. The method of claim 1 further comprising blending a first kaolin clay comprising 46 percent by weight alumina and a second kaolin clay comprising 60 percent by weight alumina in amounts effective to produce a sintered pellet comprising at least 46 percent by weight aluminum.

5. The method of claim 1 wherein the dopant is added in an amount effective to achieve sintered pellets comprising more than about 0.21 to about 1.0 percent by weight potassium oxide.

6. The method of claim 1 wherein the dopant is added in an amount effective to achieve sintered pellets comprising more than about 0.55 to about 1.06 percent by weight potassium oxide.

7. The method of claim 1 wherein the dopant is added in an amount effective to achieve sintered pellets comprising more than about 0.91 to about 3.0 percent by weight potassium oxide.

8. The method of claim 1 wherein the dopant is added in an amount effective to achieve sintered pellets comprising about 1.06 to about 3.0 percent by weight potassium oxide.

9. The method of claim 1 further comprising grinding the dopant and kaolin clay to an average particle size of less than about 15 microns.

10. The method of claim 1 wherein the pellets are sintered at a temperature of from about 1300° C. to about 1600° C.

11. The method of claim 1 wherein the pellets are sintered at a temperature of from about 1450° C. to about 1550° C.

12. The method of claim 1 wherein the pellets are sintered at a temperature of from about 1400° C. to about 1450° C.

13. A method for producing sintered pellets comprising:
mixing an effective amount of dopant selected from the group consisting of potassium carbonate, potassium sulfate, potassium chloride, mica, kalsilite, and combinations thereof with water and kaolin clay having more than 44 percent by weight aluminum oxide to form substantially round and spherical green pellets and
sintering the pellets;
wherein the sintered pellets exhibit a specific strength exceeding 88 MPa-cc/g.

14. A method for producing sintered pellets having improved quantities of mullite and glass comprising:
mixing potassium carbonate with water and kaolin clay to form substantially round and spherical green pellets and
sintering the pellets at temperatures between about 1400° C. to about 1450° C.;
wherein the potassium carbonate is added in an amount effective to achieve sintered pellets comprising more than about 0.21 to about 3.0 percent by weight potassium oxide.

15. The method of claim 14 wherein the potassium carbonate is added in an amount effective to achieve sintered particles comprising more than about 0.91 to about 3.0 percent by weight potassium oxide.

16. The method of claim 14 wherein the potassium carbonate is added in an amount effective to achieve sintered particles comprising at least 1.06 to about 3.0 percent by weight potassium oxide.

17. The method of claim 14 wherein the pellets are sintered at a temperature of about 1450° C.
